(19) United States
(12) Patent Application Publication
(10) Pub. No.: US 2002/0152202 A1
(43) Pub. Date: Oct. 17, 2002

(54) Method and system for retrieving information using natural language queries

(76) Inventors: David J. Perro, Burlingame, CA (US); Daniel J. Perro, Millbrae, CA (US); Po Chuen Li, Tempe, AZ (US); Ric Hedlund, Mesa, AZ (US)

Correspondence Address: SONNENSCHEIN NATH & ROSENTHAL, Wacker Drive Station , Sears Tower, P.O. Box #061080, Chicago, IL, 60606-1080, US

(21) Appl. No.: 09/938,879

(22) Filed: Aug. 24, 2001

Related U.S. Application Data
(60) Provisional application No. 60/228,985, filed on Aug. 30, 2000.

(51) Int. Cl. G06F 17/00

(52) U.S. Cl. 707/3

(57) ABSTRACT

The present invention provides more accurate natural language searching capabilities by generating contextual phrases that are representative of the key words in a given query and uses those key contextual phrases to locate relevant documents through a search engine or database management system. The present invention generates such contextual phrases by first tagging the text using tagging assumptions and learning methods derived from the comparison of a domain specific and naively annotated corpus. Once tagged, the system then applies matrix rules to the tagged text to create a structural representation of the text. After the generation of the structural representation of the text, the system then applies phrase generation rules, which identify the relationships of the values in the matrix and from those relationships builds a concept phrase table that represents a pattern of contextual phrases derived from the query request. The system then formats the contextual phrases for submission to a DBMS or search engine.

### BACKGROUND OF THE INVENTION

A. Field of the Invention

The present invention relates generally to an information retrieval system, and more particularly, to a method and system for the interpretation and representation of natural language queries through concept phase generation to retrieve desired information from computer based files.

B. Description of the Related Art

A natural language processing system is a computer implemented software system that allows a user of a computer to search and retrieve information and data using conversational or natural languages. Thus, the user of a natural language processing system does not have to learn the rules or syntax of a particular computer language or processing system, such as Structured Query Language (SQL), to search and retrieve information and data.

Over the past several decades, the study of natural language processing has been of some interest to both programmers and theorists alike. Computational linguistics have established several distinct protocols to propel the searching and retrieval of information by producing applications that will more accurately and speedily execute information retrieval requests. While much progress has been made in this field and many approaches explored, there has been little use of such technology in popular search applications. One example of the limited use of natural language processing (“NLP”) is the use of NLP on the World Wide Web (“Web”). According to a recent survey by NPD New Media Services, 44.8% of all people on the Web use multiple keywords to search for desired information, 28.6% use a single keyword search, 17.9% use a predefined search, and 8.7% ask for information in the form of a question. NPD New Media Services indicated that this study involved 33,000 randomly picked respondents from the first quarter of 2000. Additionally, the survey was conducted on behalf of well known search engines such as: AltaVista, AOL Search, Ask Jeeves, Excite, Go, Google, GoTo.com, HotBot, Lycos, MSN Search, Netscape Search, WebCrawler, and Yahoo.

In general, a few observations can be made about these results. The first observation addresses general awareness of such technology. That is, many people may not know that they can submit a question in NLP to any of the above search engines. In other cases, some people may have tried submitting a question to the system but found it easier to use a keyword search. In other cases, some search engines may not do a very good job of understanding the contextual relationship of words contained in a question and thus will yield less accurate results than a simple or multiple keyword search. That is, the natural language query system may only support simple noun parsing methods, thus ignoring the contextual basis of more complex questions. In addition, posted results are often based on statistical references to matching parsed words that are contained within the directory and/or database being searched. A directory in this case being a database, index, and related files that represents a much larger set of information contained in the Web. Natural language query technology should not, however, be limited to just the retrieval of information from the Web, it is also the intent to use such technology in conjunction with highly structured databases that may be pre-existing or under development.

With the advent of the Web, two main problems needed to be solved before wide spread utilization of the Web could be realized by the common personal computer (“PC”) user. The first problem solved was to develop a common way to present data to the end-user and the underlying technology through a common “browser.” An example of a popular early browser was Mosaic and later came Netscape Navigator. For the second issue, a common language needed to be adopted for content development. To resolve this problem, HTML was quickly established as the common language used to develop content for the Web.

With the proliferation of content development, the Web community moved quickly to the development of web crawlers or spider engines that were used to help solve content searching and retrieving issues. The basic function of a spider engine is to visit URL's (Web sites and associated pages) and extract specific information from the Web site. This information generally includes the URL, meta tag information (often a short description about what information is contained in the site) and page link information contained in a Web site. Web site information is then indexed and a keyword directory created so that users of the Web can use the directory to quickly find specific information.

A conventional Web query application and system includes a client device such as a PC, workstation, hybrid telephone, or Personal Digital Assistant such as a Palm Pilot. Running on the client would be some type of operating system that manages memory, storage, I/O, user interface, computational functions, and applications. The clients are connected by a network to one or more servers that are typically running a Web directory or portal application. This same or expanded set of networked servers may also contain data that is made available to users through the Web. Like the client device, the server would also run an operating system that controls memory, storage, I/O, user interface, computational functions, and applications.

With the explosion of information that has been made available on the Web, portal and search engine companies constantly have spider engines crawling the Web in an effort to keep content updated and discover new content. As a result, Web directories have grown tremendously over the past 5 years, and it has become increasingly more difficult for end-users to quickly find the most relevant response to a query using keyword search techniques. Additionally, key information captured and indexed during the spider process may not be a good representation of what information is contained at a Web site. This happens because a spider engine does not typically attempt to understand concepts contained in a Web site. Rather, the focal point is to index keywords as fast as possible and create directories that best represent what information is contained in the Web site.

In an attempt to help increase accuracy and usability, many popular portals now support natural language queries, also known as supporting a full-text query. However, many of these systems only support simple noun parsing which is inadequate for capturing the contextual relationship of words contained within a sentence or question. To illustrate this point, a request is submitted as follows to a standard full-text query (to Alta Vista search engine): “I need a list of dog groomers in Des Moines, Iowa that specialize in poodles.” In this sample request, Alta Vista found 10,718,525 pages of which none of the top ten URL listings seemed to be very closely related to the original request as shown below.

Top Ten Results Returned

1. City of West Des Moines, Iowa, USA

2. Des Moines International Airport

3. Westminster Presbyterian Church—Des Moines, Iowa

4. Color Pages, Inc. located Des Moines, Iowa offers Web Design, Web Hosting, Web

5. The Civic Center of Greater Des Moines: Bringing the Arts to Life!

6. Des Moines Iowa Weather Forecast

7. West Des Moines Chamber of Commerce

8. A Ford Dealership in Des Moines, Iowa “Sterling”

9. Des Moines General Hospital

10. Des Moines Iowa Relocation Coldwell Banker—real estate homes housing

Result Pages: 1 2 3 4 5 6 7 8 9 10 11 12 13 14 15 16 17 18 19 20 [Next>>] word count: groomers: 51; poodles: 74379; Moines: 494441; specialize: 668031; Des: 2767509; Iowa: 5015797; dog: 8901980; list of: 14684188. Ignored: that: 597199485; in: 1551367167.

From these results, this statistics-based full text query system first attempts to parse key nouns and returns results primarily based on word count statistics. Semantic attributes were lost during this process, and thus high accuracy was not achieved.

High accuracy is even more important in certain applications. For example, when using devices such as Palm Pilots and cell phones, where Internet access is provided, relevance to a query becomes much more important because screen real estate to display results is often significantly reduced. In addition, network bandwidth for such devices is typically slower. Overall, it is no longer appropriate to offer tens, hundreds, or even thousands of results to a query because it is not practical to quickly scan through query results on such devices. In order to increase accuracy and make these devices more applicable for complex queries, a system that efficiently handles natural language query and concept phrase generation can greatly improve the usability of the overall query and response system. In addition, natural language processing coupled with the concept generation technology of the present invention can be used to help solve accuracy issues associated with building Internet and Intranet category based directories. In this case, natural language processing and concept generation methods are used to extract key concepts that are contained within a domain specific corpus, i.e., a body of specific knowledge, or a much larger non-specific domain such as the Web. Concept phrases are then contained in a database index and record system thus enable fast and accurate access to queries.

It is reasonable to believe that matching a concept phrase or phrases to a concept based search engine or database will ultimately yield greater accuracy then current keyword search and retrieval systems because it more closely resembles the way people think and request information. That is, systems that strictly employ keyword search capabilities fail to extract the contextual meaning of all keywords used. For example, “I want the 1999 and 1998 annual reports for IBM and Sun” may yield keyword search results that produces high count statistical references to the words 1999, 1998, annual, reports, IBM, Sun. As a result, hundreds or thousands of results that do not capture the relationship between all of these words may be returned to the user. Understanding the contextual relationship of words helps eliminate irrelevant results that are returned in the above example.

In summary, there exists a need for a new concept based system and associated method for information query and retrieval that yields more accurate results than the more common keyword search and statistical based approaches. Furthermore, a more accurate method for query interpretation and information retrieval is needed that will enable PDAs and telephones to enhance searching capabilities. This need will enable the Web to apply the current capabilities of traditional large screen format browsers to smaller screens, such as screens of PDAs.

### SUMMARY OF THE INVENTION

Accordingly, the present invention provides more accurate natural language searching capabilities by generating a contextual lexicon and contextual rules through the comparison of a naively annotated corpus and a manually annotated, which is specific to the searching environment, using tagging assumptions and learning methods. Once generated, the contextual lexicon and contextual rules are then used to tag fresh text (i.e., queries). The system then applies matrix rules to the tagged text to create a structural representation of the text in the form of a tree matrix. Upon the generation of the tree matrix, the system identifies the relationships of the values in the matrix and from those relationships builds a concept phrase table that represents a pattern of contextual phrases derived from the query request. The system then formats the contextual phrases for submission to a DBMS or search engine. In one embodiment, the query results can then be interpreted in the same manner as the query requests by extracting key words from each query result. The conceptual interpretation of the query results can then be compared to the conceptual interpretation of the query requests to determine which results best match with the requested information.

The method of the present invention is embodied in both software and hardware embodiments in the present invention and is further explained in the detailed description given below.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a high level block diagram view of the information retrieval system of the present invention that incorporates a personal computer (“PC”) or workstation client computer, server, natural language processing (“NLP”) Application, and a repository for stored results;

FIG. 2 is a high level block diagram view of the information retrieval system of the present invention that incorporates a telephone as the client, server, NLP application, voice recognition application, and a repository for stored results;

FIG. 3 is a high level block diagram of the information retrieval system of the present invention that incorporates a personal digital assistant (“PDA”) as the client, server, NLP Application, voice recognition application, and a repository for stored results;

FIG. 4 is a high-level flow chart illustrating an embodiment of the method of the present invention as applied to a textual query;

FIG. 5 is a high level block diagram that illustrates an embodiment of the generation of the conceptual lexicon and conceptual rules by the learner through a comparison of a naively annotated corpus and training corpus;

FIG. 6 depicts an example of a tree matrix generated by an embodiment of the system of the present invention from the phrase “What airlines are advertising special fares for June-September 2000?”;

FIG. 7 depicts an example of a tree matrix generated by an embodiment of the system of the present invention from the phrase “I need information for IBM 1995-1997 annual reports”;

FIG. 8 is a table of the conceptual phrases generated by analyzing the contextual relationship between the text in the tree matrix depicted in FIG. 6; and

FIG. 9 is an embodiment of a computer system implementing the method and system of the present invention.

### DETAILED DESCRIPTION OF THE PREFERRED EMBODIMENTS

The present invention employs a natural language processing and a concept generation system that is used to form various key conceptual phrases and operands that are sent to a search engine or database for information retrieval. In general, the present invention uses custom domain specific lexicons, natural language processing rules, concept phrase generation engine, and communication logic that are then used to pass along specific requests to a database or search engine for information retrieval. Results are then analyzed for relevance versus the generated concepts, scored, and sent back to the browser (user) in ranked order.

After reviewing other natural language search applications and methods that describe high precision text retrieval systems, it is clear that the present invention can improve on existing methods. As previously described, this invention provides a new concept based system and associated methods for information query and retrieval that can yield more accurate results than the more common keyword search approaches as described above. This new invention does so by employing natural language processing and a concept generation that is used to form multiple phrases and operands that are sent to a search engine or database for information retrieval. This system and associated methods are also extensible in that they can be employed in systems that use personal computers (“PCs”), personal digital assistants (“PDA”), telephones, servers and the Web as a part of the natural language query system.

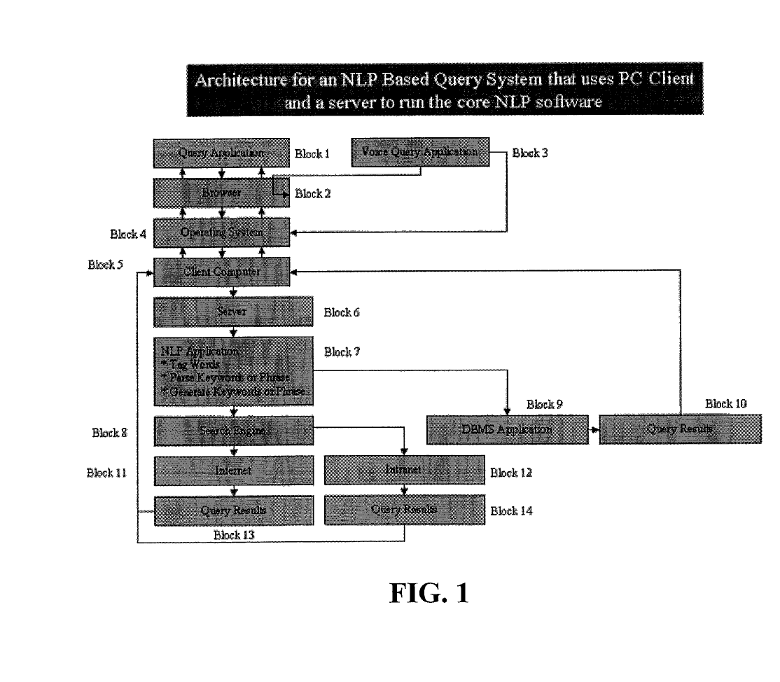

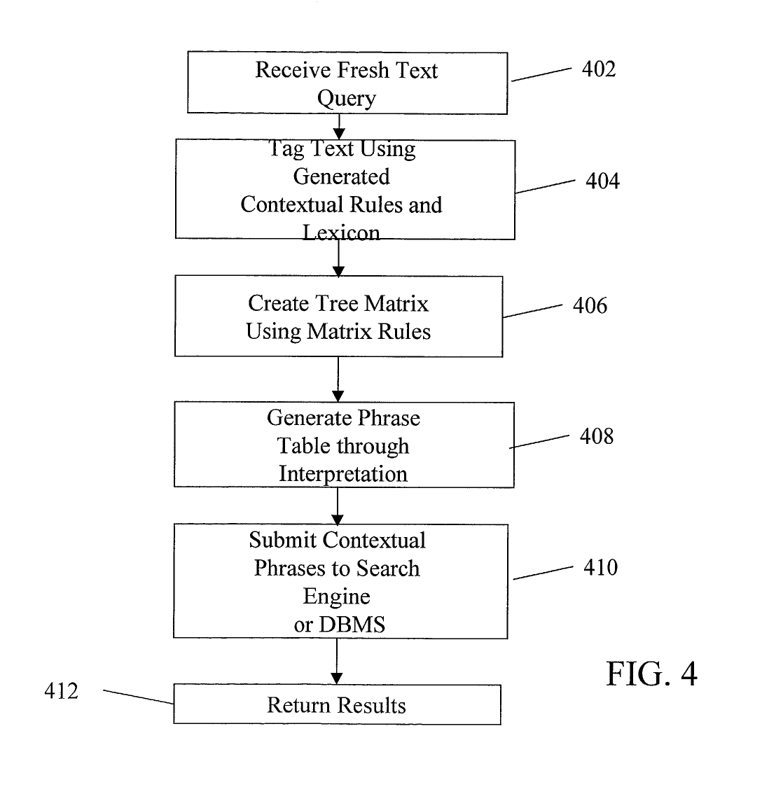

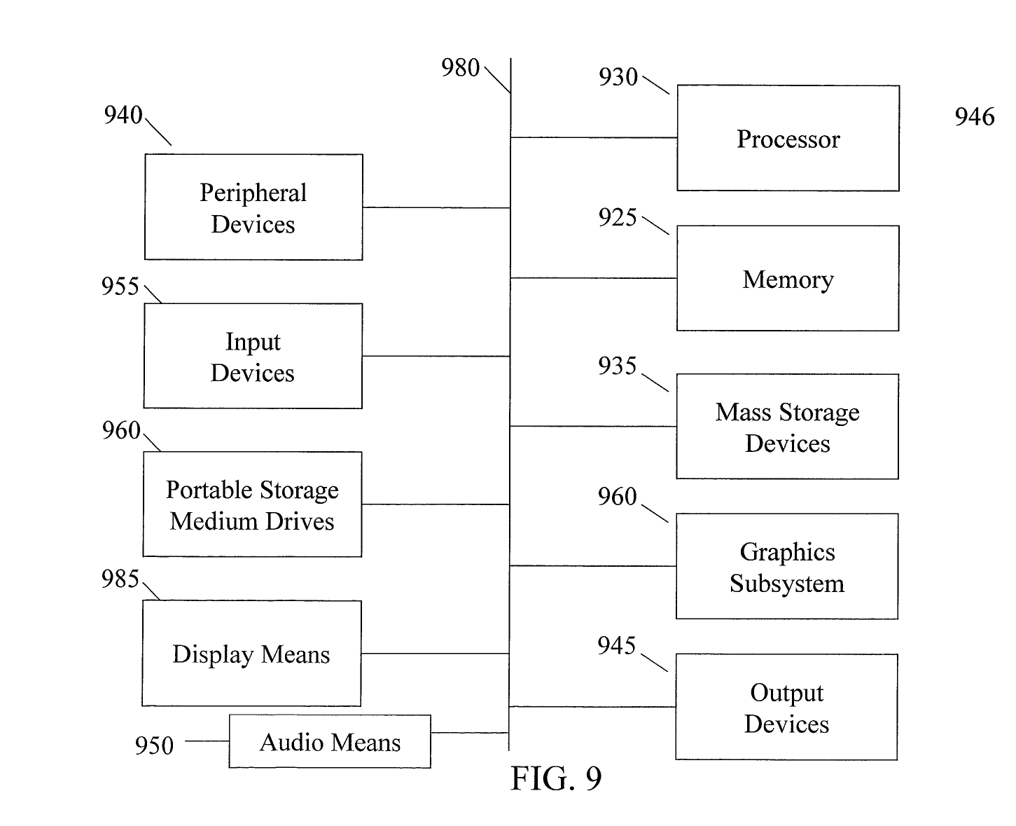

In the first embodiment, the information retrieval system of the present invention uses a PC client and server to perform an embodiment of the method for interpreting a language query described below (FIG. 4). FIG. 1 illustrates the architecture for such a system, which incorporates a PC or workstation client computer 5, server 6, NLP Application 7, and a repository for stored results 10. As shown in FIG. 1, this first embodiment utilizes a query application 1 that runs inside a standard Web browser 2, such as MS Explorer or Netscape Navigator and which supports an impute device (955 of FIG. 9). The query application 1 that runs (data input/output) inside a standard Web browser 2 communicates directly with the operating system 4, such as MS Windows 98 or Linux, and which supports voice input and speaker output through a voice query application 3. The operating system 4 runs on a client computer 5, such as a personal computer (“PC”) or Technical Workstation. The client 5 in some cases may contain voice recognition software 3.

To establish communications with a server 6 to initiate an information query, the client 5 is connected to the server 6 through a communications connection, such as a LAN, WAN, or wireless based connection. Like the client 5, the server 6 may also contain a voice recognition application.

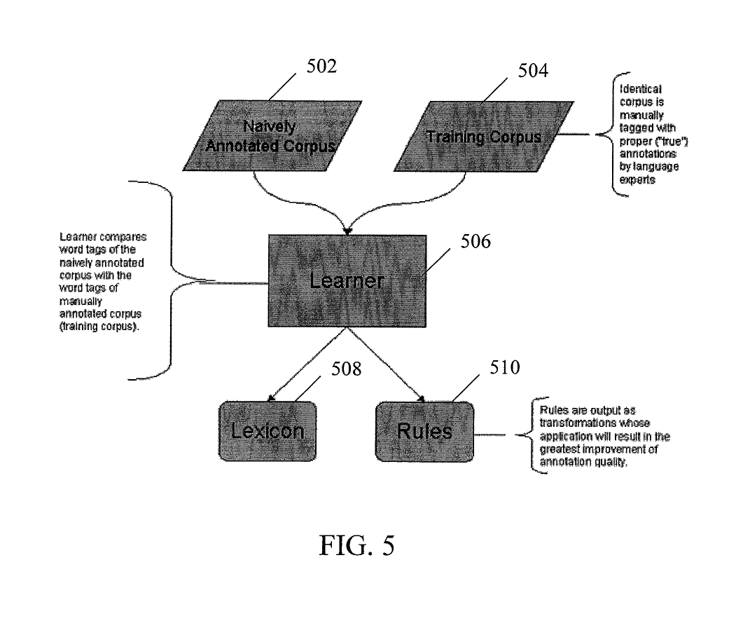

As illustrated by FIG. 5, in this embodiment, the natural language processing software 7 resides on the server 6. As will be further described below, this natural language processing software 7 contains methods for text message verification, a lexicon, methods that tag words, interprets contextual meaning of words, assembles concept phrases, and generates query submission operands for a specific information retrieval system.

FIG. 1 illustrates the retrieval of information from a database of information using a database management systems application 9 (“DBMS”), from a director, index and/or database 11 that broadly represents information contained on the Web, or from a directory, index, and/or database that broadly represents information contained on a private Intranet (Web based information protected from the public by a firewall or other security mechanism). The query results 10, 13, and 14, respectively, that are extracted from searching the DBMS, the Web directory 11 and/or the Intranet director 12 are then interpreted by an embodiment of the method for interpreting a natural language query, such as the method of FIG. 4 below.

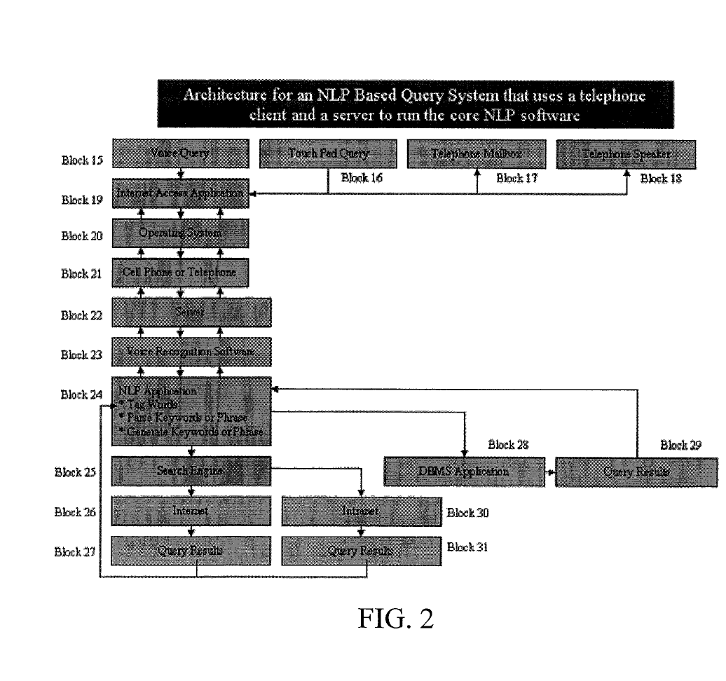

FIG. 2 illustrates yet another embodiment of the information retrieval system of the present invention. In this embodiment, the client application is a telephone or cellular telephone 21. Like the PC based system, an operating system 20 resides on the telephone 21, which will support an Internet access application 19 that will interface with telephone input/output applications, such as a touch pad query and display application 18, a telephone mailbox 17 used as a potential repository for responses to a query, and a voice query application 15 and a client telephone system 18, such as a cell phone and supporting telephonic infrastructure.

Again, like the PC based client-server application illustrated in FIG. 1, the client telephone 21 will initiate communication to a server through a communications connection, such as a LAN, WAN, or wireless based connection. When initiating voice queries, voice recognition software 23 residing on the server 22 interprets the voice query, and sends a text message to the NLP application. Thereafter, the NLP application 24 operates as described above in connection with the PC based client-server application.

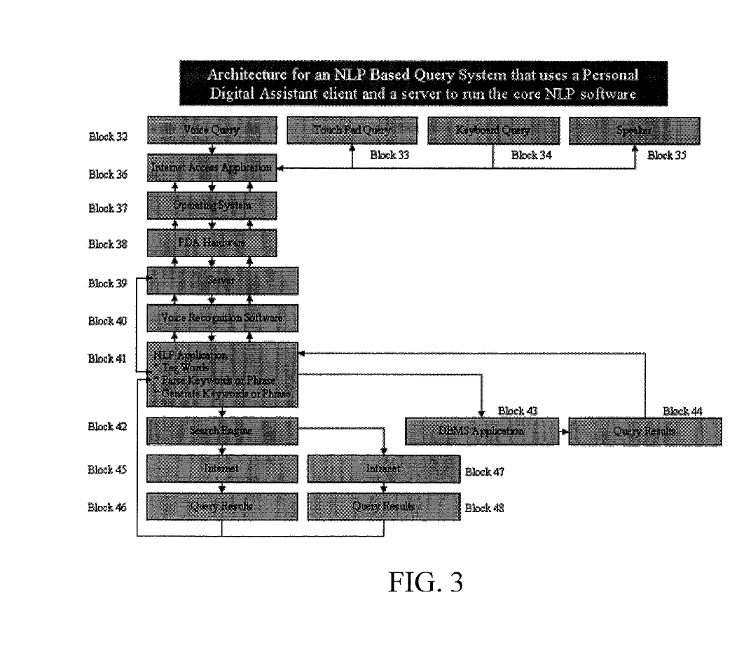

FIG. 3 represents yet another application of the information retrieval system of the present invention. In this embodiment, the client application is a personal digital assistant (“PDA”), such as a Palm Pilot®. Like the telephone and PC client, an operating system, such as Windows® CE or Palm Pilot® OS, resides on the PDA which supports an Internet access application 36. The Internet access application then interfaces with a user application, such as a voice query application 32, a touch pad query and display application 33, a keyboard query display 34, and/or a speaker 35. The client PDA initiates communication to a server through a communications connection known in the art, such as a LAN, WAN, or wireless based connection. Voice recognition software resides on the server to convert voice query into text. Thereafter, NLP application operates the same in all client-server applications described herein.

As previously discussed, the natural language processing (“NLP”) application of the present inventions can be utilized in any client-server application. The NLP application of the present invention resides on the server and communicates with the client, which, as described above, may be a PC, a telephone or a PDA.

FIG. 4 is a flow chart of an embodiment of the present method for interpreting a natural language query of the present invention. As indicated in FIG. 4, the user process begins with receipt of a natural language query from a keyboard, keypad, voice recognition system 402 or other input device. An example of such a query could be “What airlines are advertising special fares for June-September 2000?” However, before the system can properly interpret the question and generate the proper concept phrase, a contextual lexicon and contextual rules (as described below) must be developed for a specific or general purpose corpus. The lexicon and associated rules will then be integrated into a concept phrase building system that has the ability to generate more accurate results to a natural language query.

As illustrated by FIG. 5, the development process for NLP begins with the use of a manually tagged corpus 504, which, in certain circumstances, may be a domain specific corpus (i.e. a corpus 504 whose jargon and technical language are typically assigned to a particular field of study). This corpus 504 is manually annotated with part-of-speech labels, or tags. Such tags include: noun, proper noun, pronoun, adjective, verb, adverb, conjunction, preposition, determiner, etc. The manually tagged corpus 504 will then serve as a training corpus for developing tagging rules that would make a naively annotated corpus 502 mirror a manually tagged corpus. To accomplish this, the system uses algorithms (the “Learner” 506) that will learn to replicate the syntactic analysis present in the manually tagged corpus 504.

The initial-state Learner 506 consists of learning algorithms and a pre-specified knowledge base that is elementary and contains no language-specific knowledge. In this case, the pre-specified knowledge used is comprised of two components: tagging assumptions and learning methods.

In operation, the Learner first takes the same corpus used by the manually tagged corpus and tags it naively, without the use of domain specific or language specific information. This creates what is referred to above as the naively tagged corpus 502. Both the naively annotated corpus 502 and the manually tagged corpus 504 are then analyzed by the Learner 506. The Learner 506 compares the word tags of the naively annotated corpus 502 with the word tags of the manually tagged corpus 504, and then applies logic to the naive corpus 502 to make it better resemble the “true annotations” of the manually tagged corpus 504. Word tags found within the manually tagged corpus 504 become the foundation for a lexicon 508 that the Learner will refer to when tagging fresh text. Results that exhibit the greatest improvement of annotation quality are then “learned,” and output as two types of rules: lexical and contextual 510. Lexical rules 510 are based simply on the form of the word, and contextual rules 510 are dependant upon the context in which the current word is (e.g., the tags of the surrounding words.)

Going back to the original query, “What airlines are advertising special fares for June-September 2000?” The overall system first propagates this request through the architecture until it arrives at the server that contains the NLP application. As illustrated by FIG. 4, once the system receives the fresh text 402, the first step is to initially tag all words 404 before the tree matrix 406 and phrase generation 408 takes place. For this stage, the system uses blanks between words in conjunction with the use of commas, periods, question marks, hyphens, capital letters, numerical references, etc. to determine initial state semantics and basic word tagging. Additionally, lexical rules 510 are applied to the text and the words are tagged.

Examples of the morphological and syntactic tags used in the present invention to tag fresh words, are found below.

| | |
|---|---|
| Verb phrase contains | |
| Verb, base form | (examples: eat) |
| Verb, 3 sg present tense | (examples: eats) |
| Verb, past tense | (examples: ate) |
| Verb, past participle | (examples: eaten) |
| Verb, ing form | (examples: eating) |
| Preposition phrase contains | |
| Prepositions | (examples: of, in, by, for, at) |
| Conjunction phrase contains | |
| Coordinate Conjunction | (examples: and, but, or, not) |
| Date phrase contains | |
| Year | (examples: 1999) |
| Month | (examples: June) |
| Date | (examples: 12^{th}, 08-01-00, |
| | 08/01/00, Aug-01-00) |
| Week | (examples: this week, last week) |
| Day | (examples: Monday, Tuesday) |
| Adjective phrase contains | |
| Adjective | (examples: yellow) |
| Adjective, comparative | (examples: bigger) |
| Adjective, superlative | (examples: biggest) |
| Adverb, comparative | (examples: faster) |
| Adverb, superlative | (examples: most) |
| Proper Name phrase contains | |
| Proper noun, single | (examples: IBM) |
| Proper noun, plural | (examples: Carolinas) |
| Regular Noun phrase contains | |
| Noun, single or mass | |
| Noun, plural | |

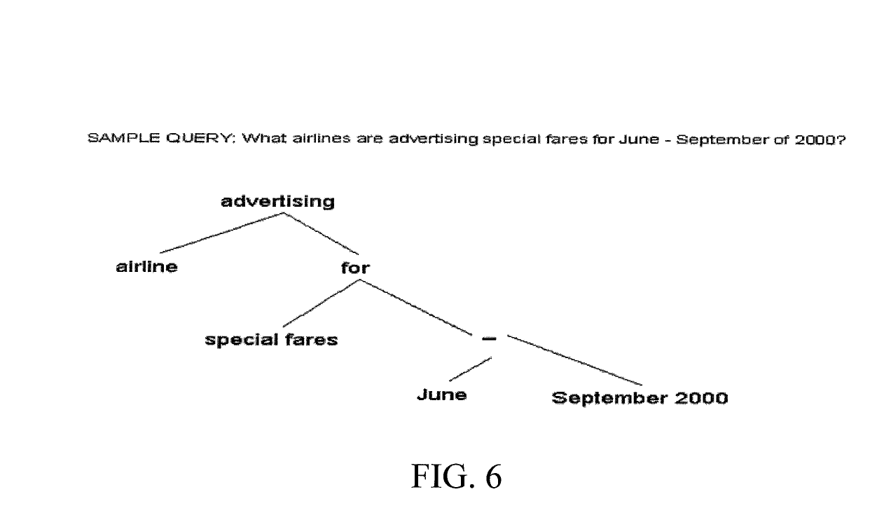

As illustrated by FIG. 4, after the text is tagged as set forth above, a set of contextual building algorithms (tree matrix rules and phrase generation rules) 406 and 408 are now applied so that the proper concept phrase or phrases may be generated and tested for accuracy before being sent to a search engine or database management application. The first set of contextual building algorithms that are applied are the algorithms that generate a tree matrix 406, similar to the matrix shown in FIG. 6. For purposes of this discussion, the algorithms used to record the structure of the query shall be referred to as the tree matrix rules or algorithms 406. Those skilled in the art will appreciate that numerous other alternatives besides matrixes or tree structures can be used for recording the structure of a query, and yet fall within the scope of the invention as claimed below.

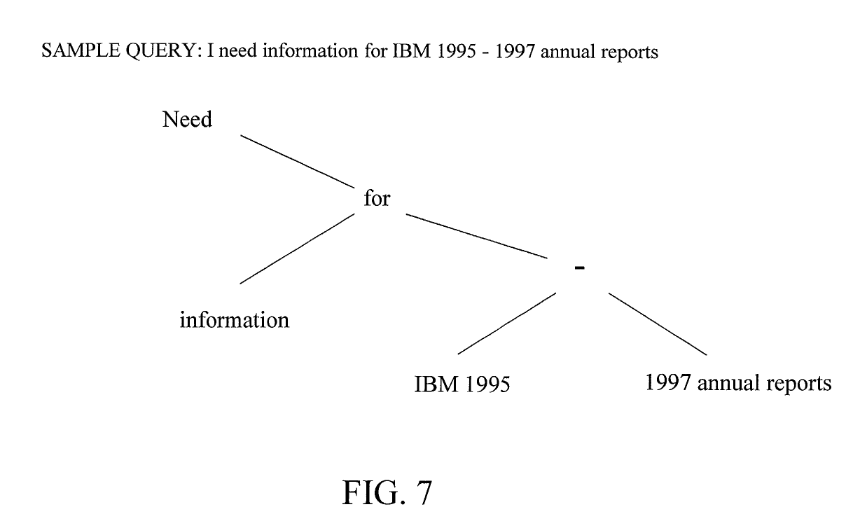

To create the tree matrix, the tree matrix rules are applied to the tagged text 406 by starting at the end of the sentence and working back toward the beginning of the sentence. The application of the tree matrix rules affects the shape of the matrix, as the tree is built dynamically as the rules are applied to the tagged texts. The textual rules create the tree matrix by recognizing which parts of speech function are nodes and which parts are the legs or leaves of the tree. Nodes are conjunctions, prepositions, verbs, and words associated with range, such as: via, through, and to. The leaves or legs are noun phrases and noun phrases used in conjunction with adverbs and adjectives. Thus, a single leg can represent a combination of a date phrase, adjective phrase, proper name phrase, regular noun phrases, or proper nouns and adjectives used in conjunction with a noun and adverbs. For instance, as illustrated by FIG. 7, “1997 annual reports” is one phrase that would be parsed into one leg of the tree matrix, which contains one date phrase (1997), one adjective phrase (annual) and one regular noun phrase (reports).

FIG. 6 is matrix view of the resulting matrix or tree structure for the query “What airlines are advertising special fares for June-September 2000?” after the tree matrix algorithms have been applied. In operation, the system, starting at the end of the sentence, recognizes the first node as the hyphen, which operates to signify range. Knowing that the first node signifies range, the tree matrix algorithm then creates two legs or leaves extending off the node that consist of the noun phrases surrounding the hyphen, which are June and September 2000. Again, noun phrases that create the legs are combinations of date phrases, nouns and/or proper nouns and nouns and proper nouns modified by adjectives or, when the node is a verb, any adverbs modifying such verb. Thus, the system recognizes the word “June” and the phrase “September 2000” both as date phrases.

Next the system recognizes the word “for” as the next node, which utilizes the hyphen as one of its legs and creates another leg with the adjective noun phrase “special fares.” The next node is then recognized as the verb “advertising,” and the last leg extending from the advertising node is the noun “airline.”

Similarly, FIG. 7 shows the resulting matrix from the query “I need information for IBM 1995-1997 annual reports.” The logic of the system is such that the words of the sentence are tagged as follows: “need” is tagged as a verb; “information” is tagged as a noun; “for” is tagged as a preposition, “IBM” is tagged as a proper noun; “1995” is recognized as a date; the hyphen is tagged as a word functioning similar to a conjunction; “1997” is recognized as a date; “annual” is recognized as an adjective; and “reports” is tagged as a plural noun. Since nodes are conjunctions, prepositions, verbs, and words associated with range, such as: via, through, and to, the tree matrix algorithms, when applied to the tagged text, recognize the hyphen as the first node, “for” as the second node, and “need” as the final node, or top node of the matrix. One leg of the hyphen is the noun phrase IBM 1995, consisting of the proper noun (IBM) and the date phrase (1995). The other leg is the noun phrase “1997 annual reports,” which consists of the date phrase (1997), the adjective (annual) and the plural noun (reports). The second node is then built on the first node and has a single terminal leg, extending therefrom. The single terminal leg extending from the second node is recognized as the noun “information”; the other leg connects the first node with the second node. The next node, which is the verb “need” is then connected to the second node. The word “I” is ignored. Thus, the tree matrix is completed, as illustrated in FIG. 7.

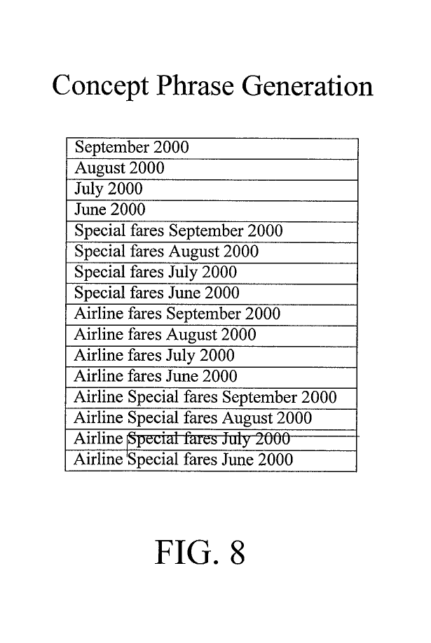

After the creation of the tree matrix, the system then applies the second set of the contextual building algorithms, which is the phrase generation rules or algorithms. The application of the phrase generation rules creates a table of key phrases 408, as illustrated by FIG. 8, which are subsequently fed into a search engine or database management system 410 to retrieve the information being requested by the original text query of the user 412.

The interpretation of the tree matrix and the relationship between the legs and the nodes of matrix are a part of the application of the phrase generation rules. As seen in FIGS. 6 and 7, each tree matrix contains two different kinds types of nodes: embryo nodes and parent nodes. Parent nodes are defined as nodes with at least one child node, i.e., with at least one leg that is a node which is a verb, preposition, or word designating a range. Embryo nodes are defined as nodes with no child node, i. e., both legs are terminal and represent noun phrases.

Given the above interpretation of the tree matrix, rules are then applied to create a table of phrases 408 (FIG. 4), similar to the table illustrated in FIG. 7, that represents a series of phrases that are highly relevant to locating documents relevant to the user's query. A representative sample of such phrase generation rules, as applied to the tree matrix in FIG. 7, is found below:

Two child nodes of conjunctions can be combined together based on the following rules:

If the left node has proper name and the right node has no proper name

Then add proper name to the right leaf node.

Example:

IBM 1995 and 1997 annual report=>IBM 1997 annual reports

If the left node has date and the right node does not have date

Then add date to the right leaf node.

If the left node has adjective and right node does not have adjective

Then add adjective to the right leaf node.

Two child nodes of the nodes which have words associated with range can be combined together based on the following rules:

If the parent node has words associated with range (i.e., via, through, to)

And if parent node has date in the left child and has date in the right child

Then date within the range are formed.

Example:

1995-1997=>1995, 1996, 1997

Two child nodes of preposition can be combined together based on the following rules:

If the parent node is preposition phrase

Then combine the left child with the right child together

Example:

(Information) FOR (IBM)=>Information IBM

If the parent node is verb phrase

Then combine the left child plus itself plus the right child together

Example:

(Web server) DEVELOPED by (IBM)=>Web server developed IBM

Based on the rules listed above, “IBM 1995-1997 annual reports” generates the following phrases:

IBM 1995 annual reports

IBM 1996 annual reports

IBM 1997 annual reports

“Information for IBM 1995-1997 annual reports” generates the following phrases:

information IBM 1995 annual reports

information IBM 1996 annual reports

information IBM 1997 annual reports

“need information for IBM 1995-1997 annual reports” generates the following phrases:

need information IBM 1995 annual reports

need information IBM 1996 annual reports

need information IBM 1997 annual reports

FIG. 6 is a matrix view of the an application of the phrase generation rules to the matrix resulting from the query, “What airlines are advertising special fairs for June-September of 2000?” In FIG. 6, starting at the bottom of the matrix, a hypen is used that has a particular use in this embodiment of the present invention. When used to separate Proper nouns such as June and September, the systems correctly identifies this as a range request and must be treated so in relationship to higher values in the matrix.

Moving up in the matrix, we see that the system understands and establishes contextual relationships between adjectives and nouns. Additionally the system must score the adjective to determine the value of the relationship to the noun when constructing possible concept phrases. That is, in the example above the word special is relevant, but it may not help the system extract the best or most complete set information when searching airline fares from June through September of 2000. In this embodiment, the system may also extract fare information that is not specified as special but still relevant to the query. For example, the regular price of airline fares from one airline may be lower than another airlines special fares.

With regard to the use of conjunctions, conjunctions are regarded with high priority as they are commonly used to connect words, phrases, and clauses in a sentence or question. In this embodiment, the word “for” establishes the relationship between the desired range of dates and the concept phrase “special airline fares”.

At the top of the matrix, the noun word “airline” and the verb “advertising” are shown. Clearly, “airline” is a critical noun and important to the contextual meaning of this sentence. In the case of the verb “advertising,” it is scored as being less valuable to the overall request and thus will not be determined as imperative when creating the concept phrase table.

After the contextual learner has built and validated key concepts and semantic relationships between the parsed words, the system will then initiate concept phrase building process that will build a concept phrase table. The main purpose for this process is to properly prepare the data that will ultimately be submitted to a search engine or database application. FIG. 8 illustrates the table that would be derived during this process.

Once the concept phrase table has been built, the system will use the appropriate request arguments for the applicable database application of search engine and submit them to the destination database application or search engine. In each case, the natural language query and concept phrase generation system will interface with the search engine 410 or DBMS application in a unique way.

In a further embodiment, after the results of the query request are generated 412, data can then be extracted from the query request and parsed through the natural language processing application in the same manner as the query request. The resulting phrases generated from the query results can then be compared to the phrases generated by query request to identifying to assist in determining the relevance of the generated output.

FIG. 9 illustrates a high-level block diagram of a general purpose computer system which is used, in one embodiment, to implement the method and system of the present invention. The general purpose computer, in one embodiment, acts as either the client computer 5 of FIG. 1, the cell phone or telephone 21 of FIG. 2 (in another embodiment) or the personal digital assistance of FIG. 3 (in still a further embodiment). The general purpose computer 946 of FIG. 9 includes a processor 930 and memory 925. Processor 930 may contain a single microprocessor, or may contain a plurality of microprocessors, for configuring the computer system as a multi-processor system. Memory 925, stores, in part, instructions and data for execution by processor 930. If the system of the present invention is wholly or partially implemented in software, including computer instructions, memory 925 stores the executable code when in operation. Memory 925 may include banks of dynamic random access memory (DRAM) as well as high speed cache memory.

The computer system of FIG. 9 further includes a mass storage device 935, peripheral device(s) 940, audio means 950, input device(s) 955, portable storage medium drive(s) 960, a graphics subsystem 980, and a display means 985. For purposes of simplicity, the components shown in FIG. 9 are depicted as being connected via a single bus 980 (i.e., transmitting means). However, the components may be connected through one or more data transport means (e.g., Internet, Intranet, etc.). For example, processor 930 and memory 925 may be connected via a local microprocessor bus, and the mass storage device 935, peripheral device(s) 940, portable storage medium drive(s) 960, and graphics subsystem 980 may be connected via one or more input/output (I/O) buses. Mass storage device 935, which is typically implemented with a magnetic disk drive or an optical disk drive, is in one embodiment, a non-volatile storage device for storing data and instructions for use by processor 930. In another embodiment, mass storage device 935 stores the components of the client server 4. In another embodiment, the storage device may also be the mass storage device 935. The computer instructions that implement the method of the present invention also may be stored in processor 930.

Portable storage medium drive 960 operates in conjunction with a portable non-volatile storage medium, such as a floppy disk, or other computer-readable medium, to input and output data and code to and from the computer system of FIG. 9. In one embodiment, the method of the present invention that is implemented using computer instructions is stored on such a portable medium, and is input to the computer system 946 via the portable storage medium drive 960. Peripheral device(s) 940 may include any type of computer support device, such as an input/output (I/O) interface, to add additional functionality to the computer system 946. For example, peripheral device(s) 940 may include a network interface card for interfacing computer system 946 to a network, a modem, and the like.

Input device(s) 955 provide a portion of a user interface. Input device(s) 955 may include an alpha-numeric keypad for inputting alpha-numeric and other key information, or a pointing device, such as a mouse, a trackball, stylus, or cursor direction keys. In order to display textual and graphical information, the computer 946 of FIG. 9 includes graphics subsystem 980 and display means 985. Display means 985 may include a cathode ray tube (CRT) display, liquid crystal display (LCD), other suitable display devices. Graphics subsystem 980 receives textual and graphical information and processes the information for output to display 985. The computer system 946 of FIG. 9 also includes an audio system 950. In one embodiment, audio means 950 includes a sound card that receives audio signals from a microphone that may be found in peripherals 940. In another embodiment, the audio system 950 may be a processor, such as processor 930, that processes sound. Additionally, the computer of FIG. 9 includes output devices 945. Examples of suitable output devices include speakers, printers, and the like.

The devices contained in the computer system of FIG. 9 are those typically found in general purpose computers, and are intended to represent a broad category of such computer components that are well known in the art. The system of FIG. 9 illustrates one platform which can be used for practically implementing the method of the present invention. Numerous other platforms can also suffice, such as Macintosh-based platforms available from Apple Computer, Inc., platforms with different bus configurations, networked platforms, multi-processor platforms, other personal computers, workstations, mainframes, navigation systems, and the like.

In a further embodiment, the present invention also includes a computer product which is a computer readable medium (media) having computer instructions stored thereon/in which can be used to program a computer to perform the method of the present invention as shown in FIGS. 4-8. The storage medium can include, but is not limited to, any type of disk including floppy disks, optical disks, DVD, CD ROMs, magnetic optical disks, RAMs, EPROM, EEPROM, magnetic or optical cards, or any type of media suitable for storing electronic instructions.

These same computer instructions may be located in an electronic signal that is transmitted over a data network that performs the method as shown in FIGS. 4-8 when loaded into a computer. The computer instructions are in the form of data being transmitted over a data network. In one embodiment, the method of the present invention is implemented in computer instructions and those computer instructions are transmitted in an electronic signal through cable, satellite or other transmitting means for transmitting the computer instructions in the electronic signals.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the method of the present invention as described above.

Although the present invention has been described in detail with respect to certain embodiments and examples, variations and modifications exist which are within the scope of the present invention as defined in the following claims.

What is claimed is:

1. A method for interpreting a natural language query, comprising:
providing a contextual lexicon and contextual rules;
receiving the natural language query, the natural language query having a plurality of text;
tagging the plurality of text using the contextual lexicon and contextual rules;
creating a structural representation of the plurality of text using a plurality of matrix rules;
generating a plurality of conceptual phrases to be submitted to an application for interpreting the plurality of conceptual phrases using a plurality of phrase generation rules applied to the structural representation of the plurality of text.

2. The method of claim 1, further comprising the steps of:
formatting the plurality of concept phrases contained in a the concept phrase table to be understood by a search engine or database management systems application, the formatting step creating a formatted concept phrase; and
submitting the formatted concept phrase to the search engine or database management system to extract information relevant to the concept phrase.

3. The method of claim 1, further comprising the steps of:
formatting the plurality of concept phrases contained in a the concept phrase table to be understood by a search engine or database management systems application, the formatting step creating a formatted concept phrase;
submitting the formatted concept phrase to the search engine or database management system to obtain extracted information relevant to the concept phrase;
obtaining the extracted information from the search engine or database management system;
generating a plurality of second concept phrases from the extracted information for comparison to the plurality of concept phrases;
comparing the plurality of second concept phrases to the plurality of concept phrases; and
ranking the extracted information in order of relevance based on the comparing step.

4. A computer readable storage medium having a computer program stored thereon for processing natural language queries, that, when loaded on a computer, the computer program causing the computer to perform a method for interpreting a natural language query, the method comprising:
providing a contextual lexicon and contextual rules;
receiving the natural language query, the natural language query having a plurality of text;
tagging the plurality of text using the contextual lexicon and contextual rules;
creating a structural representation of the plurality of text using a plurality of matrix rules;
generating a plurality of conceptual phrases to be submitted to an application for interpreting the plurality of conceptual phrases using a plurality of phrase generation rules applied to the structural representation of the plurality of text.
